(19) United States
(12) Patent Application Publication
(10) Pub. No.: US 2010/0329168 A1
(43) Pub. Date: Dec. 30, 2010

(54) Frequency Band Assignment Method for a Wireless Communication System and Device Using the Same

(76) Inventors: Cheng-Hsuan Wu, Taipei City (TW); Yuan-Chin Wen, Taipei City (TW); Feng-Chi Wu, Nantou County (TW); Jiunn-Tsair Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/632,810

(22) Filed: Dec. 8, 2009

(30) Foreign Application Priority Data
Jun. 30, 2009 (TW) 098122041

(51) Int. Cl. H04W 72/04; H04H 20/71

(52) U.S. Cl. 370/312; 370/329; 370/338

(57) ABSTRACT

A frequency band assignment method for a wireless communication system is disclosed. The wireless communication system includes a plurality of base stations. The plurality of base stations has overlapped radio ranges and forms a plurality of independent overlapping areas. The method includes steps of modeling the plurality of base stations as a plurality of variable nodes in a factor graph, modeling the plurality of independent overlapping areas as a plurality of constraint nodes in the factor graph, and using the factor graph to perform frequency assignment for the plurality of base stations. Each variable node is defined as a frequency band to be assigned to the modeled base station. Each constraint node is defined as that the frequency bands assigned to the base stations forming the modeled overlapping area cannot be equivalent.

### BACKGROUND OF THE INVENTION

1. Field of the Invention

The present invention relates to a frequency band assignment method and device for a wireless communication system, and more particularly, to a method and device of using a graphic interface to model an overlapping base station problem in a multicast scenario for performing frequency band assignment.

2. Description of the Prior Art

In a wireless communication system, e.g. a wireless local area network (WLAN), if two or more base stations (unrelated with each other) have overlapped radio ranges and operate in the same frequency band, signals transmitted by a wireless device within a radio range of one base station may interfere with the one within a radio range of another base station. It is called an overlapping basic service sets (OBSS) problem in the WLAN field.

Please refer to FIG. 1, which illustrates the base station overlapping problem in wireless transmission. In FIG. 1, base stations BS1 and BS2 operate in the same frequency band and have an overlapped radio range (e.g. slash area). In this situation, if the base stations BS1 and BS2 simultaneously intend to transmit data to a wireless device STA1 within the overlapped radio range, since the base stations BS1 and BS2 are not within each other's radio range, namely the base stations BS1 and BS2 can not detect the existence of the other party, when one base station transmits data to the wireless device STA1, the other base station may mistakenly consider that the frequency band is empty, and also transmit its data. As a result, data collision occurs, causing all data sent to the wireless device STA1 are lost.

In a unicast scenario, the aforementioned hidden terminal problem can be solved by a Request To Send (RTS)/Clear To Send (CTS) mechanism. In the RTS/CTS mechanism, the transmission terminal sends an RTS packet before transmitting data, and the reception terminal sends a CTS packet when receiving the RTS packet, to inform the transmission terminal that data transmission can start over and to inform other wireless devices that no data transmission is allowed in this period to avoid collision. However, the RTS/CTS mechanism can not be applied to a multicast scenario. Thus, in the multicast scenario, the base station overlapping problem conventionally is solved by assigning different frequency bands to the adjacent base stations with overlapped radio ranges.

Please refer to FIG. 2 and FIG. 3. FIG. 2 and FIG. 3 individually illustrate a frequency band assignment scheme for two particular network topologies in the prior art. Generally speaking, the prior art follows a “First Come First Serve” policy to select the frequency band. For example, if the base station BS1 selects a frequency band F_{A} first for multicast transmission, the adjacent base station with the radio range overlapped then selects a different frequency band F_{B} from available frequency bands of this base station. The frequency bands of the rest base stations are selected in like manners. However, the “First Come First Serve” policy is only adapted to few particular network topologies. As complexity of the network topology increases, under a situation that the number of frequency bands available for each base station is limited, how to effectively assign the frequency bands to the base stations in the multicast scenario is still an open problem.

### SUMMARY OF THE INVENTION

It is therefore an objective of the present invention to provide a frequency band assignment method and device for a wireless communication system.

The present invention discloses a frequency band assignment method for a wireless communication system. The wireless communication system comprises a plurality of base stations. The plurality of base stations has overlapped radio ranges and forms a plurality of independent overlapping areas. The frequency band assignment method comprises the steps of modeling the plurality of base stations as a plurality of variable nodes in a factor graph, each variable node having a variable defined as a frequency band to be assigned to the modeled base station, modeling the plurality of independent overlapping areas as a plurality of constraint nodes in the factor graph, each constraint node connected to the variable nodes that the corresponding base stations form the modeled overlapping area, and having a constraint defined as that the frequency bands assigned to the base stations forming the modeled overlapping area cannot be equivalent and using the factor graph to perform frequency assignment for the plurality of base stations.

The present invention further discloses a frequency band assignment device for a wireless communication system. The frequency band assignment device is utilized for executing the said frequency band assignment method to perform frequency assignment for the wireless communication system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a base station overlapping problem in wireless transmission.

FIGS. 2 and 3 individually illustrate a frequency band assignment scheme for two particular network topologies in the prior art.

FIG. 4 is a schematic diagram of a factor graph.

FIG. 5 is a flowchart of a process according to an embodiment of the present invention.

FIG. 6 is a schematic diagram of a network topology with the overlapping base station problem according to embodiment of the present invention.

FIG. 7 illustrates a factor graph generated by modeling the network topology in FIG. 6 according to the embodiment of the present invention.

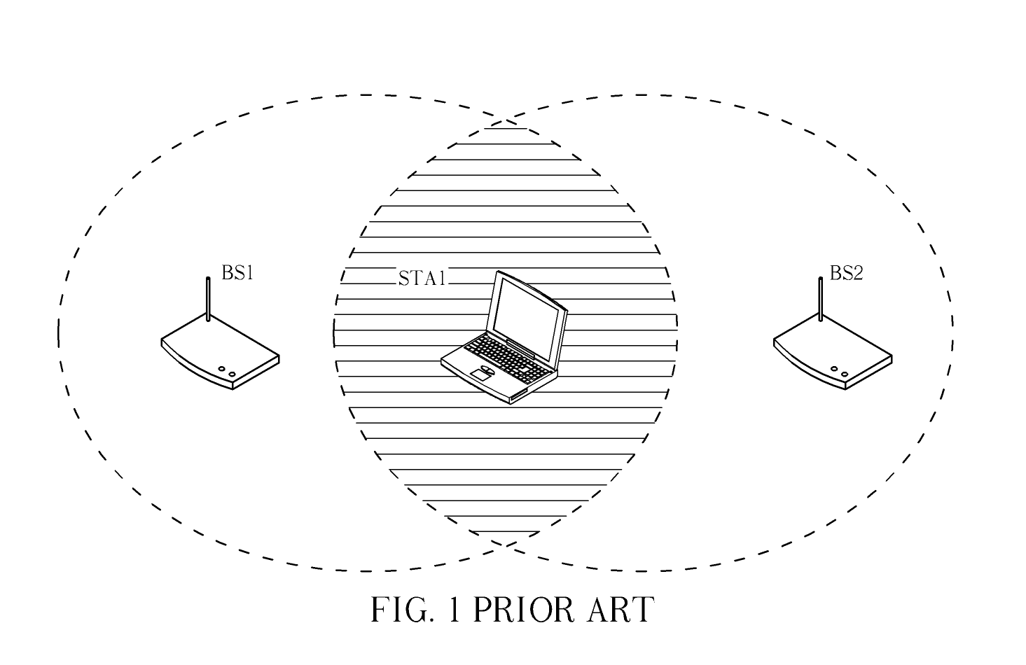

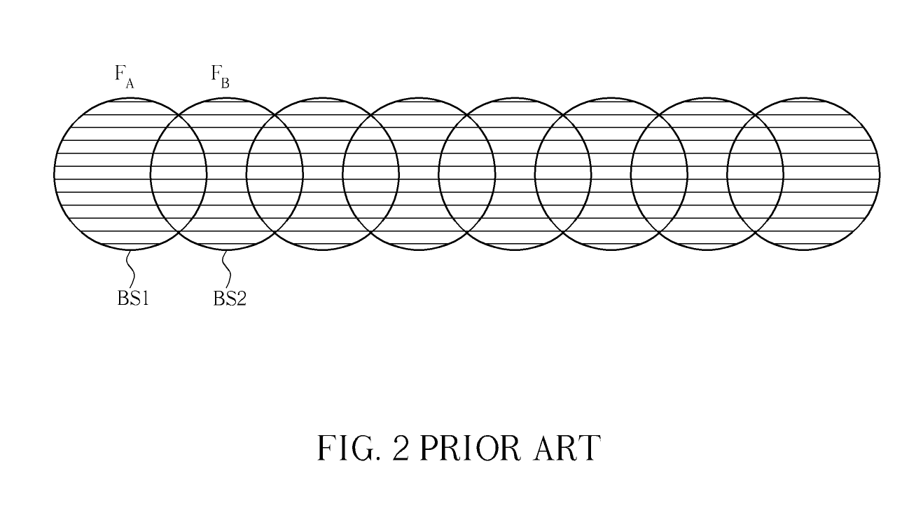

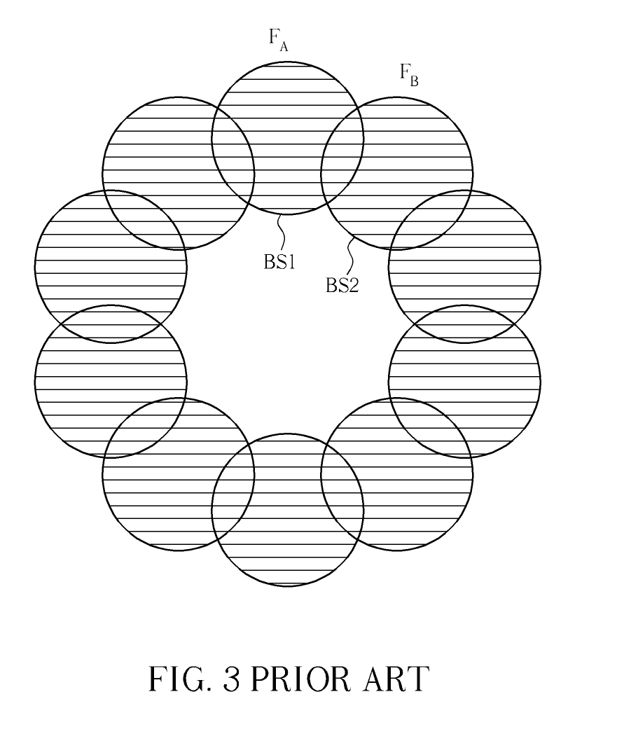

### DETAILED DESCRIPTION

By using the distributed property of the network, the present invention proposes to use a factor graph, which has a distributed computing property in nature, to model an overlapped base station problem in a multicast scenario for effectively performing the frequency band assignment on different network topologies, and improving disadvantages in the prior art.

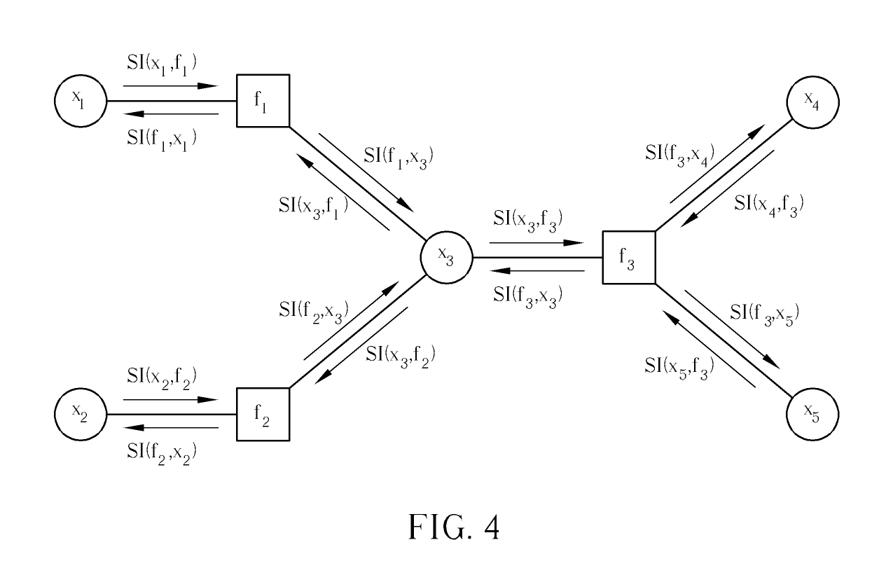

The factor graph adopts Sum-Product Algorithms to effectively process all kinds of coding in communication, signal processing and artificial intelligence in view of graph. First of all, please refer to FIG. 4, which is a schematic diagram of a factor graph. It is utilized for solving an equation, given by:

f(x₁,x₂,x₃,x₄,x₅)=f₁(x₁,x₃) ·f₂(x₂,x₃)·f₃(x₃,x₄,x₅) (Eq. 1)

As known from Eq.1, the function f represents a product of functions f1, f2 and f3. Meanwhile, the function f1 is merely associated with variables x1 and x3; the function f2 is merely associated with variables x2 and x3; the function f3 is merely associated with variables x3, x4 and x5. Factor graph is to deal with the relation between the variable and function in view of graph. Taking FIG. 4 as an example, each function is represented by a block, called constraint node or agent node, and the variables x1˜x5 are represented by a circle, called variable node. The connections between the constraint nodes and the variable nodes depend on the relation of the functions and the variables. For example, the function f1 is merely associated with the variables x1 and x3. The constraint node representing the function f1 is connected with only the variable nodes representing the variables x1 and x3. By the same token, factor graph can be illustrated as shown in FIG. 4. On the other hand, information transmitted between the constraint nodes and the variable nodes is soft information SI. Each SI is merely associated with the adjacent constraint nodes and variable nodes and can determine its content according to other related soft information. For example, the soft information SI(x3, f3) from the variable node x3 to the constraint node f3 can be represented by:

SI(x₃, f₃)=SI(f₁,x₃)·SI(f₂,x₃)

Accordingly, a result of f (x1, x2, x3, x4, x5) can be yielded as long as the number of times that the soft information is transmitted and processed are sufficient.

In addition to simplifying the complicated computations, since the relation between the functions and the variables are expressed in view of graph, the factor graph can be easily extended by determining the relation of new nodes and original nodes when intending to extend the computational constraint.

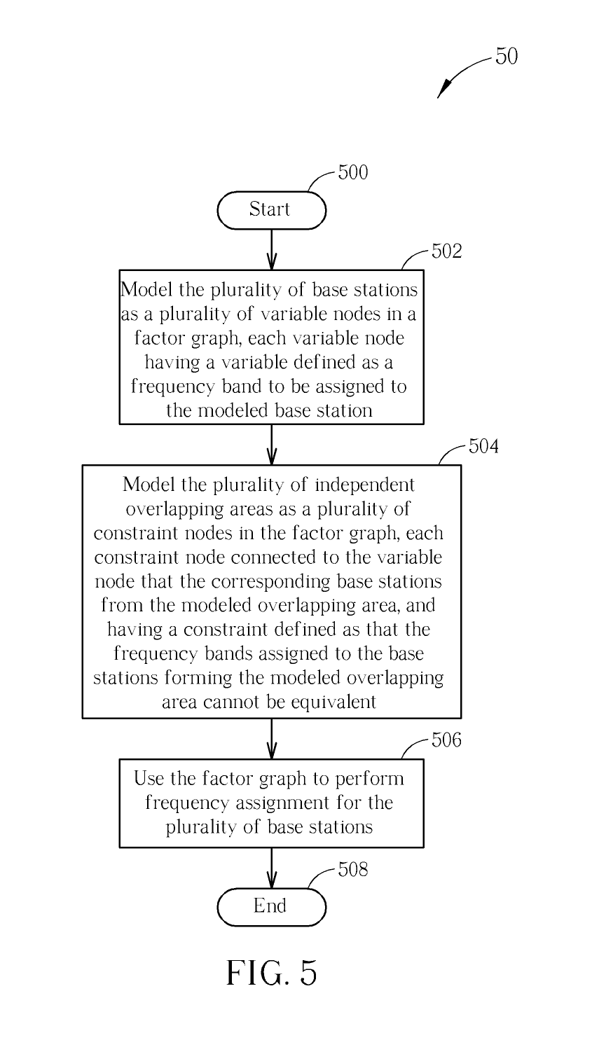

Please refer to FIG. 5, which is a flowchart of a process 50 according to an embodiment of the present invention. The process 50 is utilized for implementing a frequency band assignment for a wireless communication system. The wireless communication system, e.g. wireless local area network (WLAN), includes multiple base stations. The base stations have overlapped radio ranges and form multiple independent overlapping areas. The process 50 includes the following steps:

Step 500: Start.

Step 502: Model the plurality of base stations as a plurality of variable nodes in a factor graph, each variable node having a variable defined as a frequency band to be assigned to the modeled base station.

Step 504: Model the plurality of independent overlapping areas as a plurality of constraint nodes in the factor graph, each constraint node connected to the variable node that the corresponding base stations from the modeled overlapping area, and having a constraint defined as that the frequency bands assigned to the base stations forming the modeled overlapping area cannot be equivalent.

Step 506: Use the factor graph to perform frequency assignment for the plurality of base stations.

Step 508: End.

According to the process 50, the embodiment of the present invention models the base stations with radio ranges overlapped as variable nodes in a factor graph and defines each independent overlapping area formed by the aforementioned base stations as constraint nodes. The variable of each variable node represents the frequency band assigned to each base station. Each constraint node is connected to the variable nodes that the corresponding base stations form the modeled independent overlapping area. The constraint is defined by that the base stations forming the modeled overlapping areas are assigned to different frequency bands. Consequently, the embodiment of the present invention can uses the factor graph, which has the distributed computing property in nature, to model the overlapping base station problem in multicast scenario, and effectively perform frequency band assignment for various network topologies. In addition, since the constraint is only associated with the variable nodes connected with the constraint nodes, the embodiment of the present invention further reduces the complexity of the frequency band assignment for all network topologies.

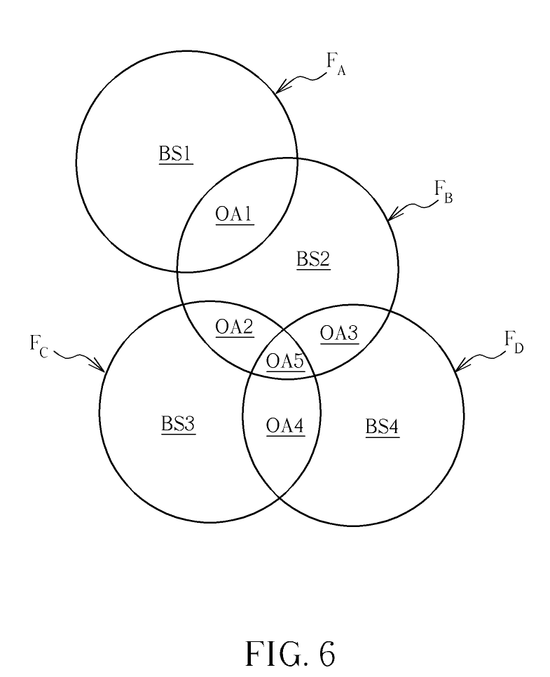

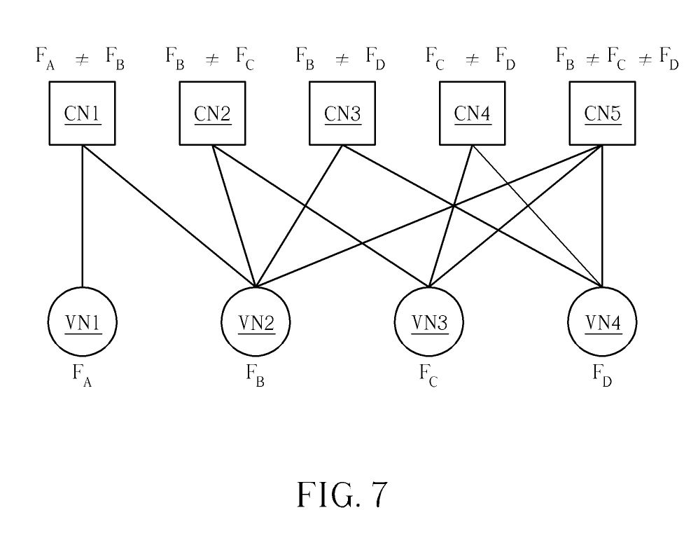

For example, please refer to FIG. 6, which is a schematic diagram of a network topology with the overlapping base station problem. As shown in FIG. 6, base stations BS1˜BS4 have overlapped radio ranges and forms independent overlapping areas OA1˜OA5. Assume that the circles represent the variable nodes and the blocks represent the constraint nodes, a factor graph, which is generated by modeling the network topology in FIG. 6 according to the embodiment of the present invention is illustrated as FIG. 7. In FIG. 7, variable nodes VN1˜VN4 corresponds to the base stations BS1˜BS4 and represent frequency bands F_{A}˜F_{D} being assigned to each base station, respectively. Constraint nodes CN1˜CN5 corresponds to overlapping areas OA1˜OA5, and are connected to the variable nodes that the corresponding base stations form the modeled overlapping area. The constraint nodes CN1˜CN5 are utilized for representing the constraints that the base stations forming the overlapping area shall be assigned to different frequency bands.

For example, the constraint node CN1 corresponds to the overlapping area OA1 formed by the base stations BS1 and BS2. Thus, the constraint node CN1 must be connected to the variable nodes VB1 and VB2 corresponding to the base stations BS1 and BS2, and represents a constraint as that the frequency band FA assigned to the base station BS1 is not equivalent to the frequency band FB assigned to the base station BS2 (i.e. F_{A}≠F_{B}). Likewise, the constraint node CN5 corresponds to the overlapping area formed by the base station BS2, BS3 and BS4. Thus, the constraint node CN5 must be connected to the variable nodes VN2, VN3, and VN4 corresponding to the base station BS2, BS3 and BS4, and represents a constraint as F_{B}≠F_{C}≠F_{D}.

After each node has been defined in the factor graph, the soft information is transmitted back and forth between the variable nodes and the constraint nodes by the following steps to determine the frequency band assigned to each base station: Step 1: Initialize the variable nodes (e.g. initialize probability of all frequency bands available for each base station); Step 2: Transmit the soft information from the variable nodes to the constraint nodes; Step 3: Transmit the soft information from the constraint nodes back to the variable nodes; Step 4: Stop transmitting the soft information according to a predetermined stopping criterion and make a hard decision. After the hard decision, the frequency band of each base station for multicast transmission is selected according to negotiation results of the variable nodes and the constraint nodes. The aforementioned factor graph operations are well known by those skilled in the art, and therefore not detailed here.

Please note that the base station overlapping problem only occurs when the overlapping area exists wireless devices intending to receive data. Thus, in the embodiment of the present invention, the aforementioned constraints are supported only if each overlapping area includes at least one wireless device. In this situation, the embodiment of the present invention can regard the base stations and wireless devices within the overlapping area as the aforementioned variable nodes and constraint nodes, respectively and solve the base station overlapping problem by distributed computing of the factor graph.

Further, the embodiment of the present invention can enhance the frequency band assignment efficiency by weighting the constraints. For example, when one base station only has few frequency bands to select, the constraint is weighted to determine the priority of the frequency bands for the base station. Such variation is also included in the scope of the present invention.

As for hardware implementation, the meanings of the base stations and wireless devices can be defined according to requirements of different wireless communication system. For a WLAN, the base station is defined as an access point and the wireless device could represent a device equipped with a wireless adapter, such as a laptop or related network equipments.

To sum up, the present invention uses the distributed computing property of the factor graph to model the overlapping base station problem in the multicast scenario based on the distributed property of the network, such that the frequency band assignment can be effectively performed for all kinds of network topologies, and thereby the disadvantages in the prior art are improved.

Those skilled in the art will readily observe that numerous modifications and alterations of the device and method may be made while retaining the teachings of the invention.

What is claimed is:

1. A frequency band assignment method for a wireless communication system, the wireless communication system comprising a plurality of base stations, the plurality of base stations having overlapped radio ranges and forming a plurality of independent overlapping areas, the frequency band assignment method comprising the steps of:
modeling the plurality of base stations as a plurality of variable nodes in a factor graph, each variable node having a variable defined as a frequency band to be assigned to the modeled base station;
modeling the plurality of independent overlapping areas as a plurality of constraint nodes in the factor graph, each constraint node connected to the variable nodes that the corresponding base stations form the modeled overlapping area, and having a constraint defined as that the frequency bands assigned to the base stations forming the modeled overlapping area cannot be equivalent; and
using the factor graph to perform frequency assignment for the plurality of base stations.

2. The frequency band assignment method of claim 1, wherein each of the plurality of independent overlapping areas comprises at least one wireless device.

3. The frequency band assignment method of claim 1, wherein the variable of each variable node is further defined as assignment probability of the frequency bands available for each base station.

4. The frequency band assignment method of claim 1, wherein the step of using the factor graph to perform frequency band assignment for the plurality of base stations comprises:
initializing the plurality of variable nodes;
transmitting soft information associated with the frequency band assignment back and forth between the mutually connected variable nodes and constraint nodes;
stopping transmitting the soft information according to a predetermined stopping criterion and making a hard decision to determine the frequency bands assigned to the plurality of base stations.

5. The frequency band assignment method of claim 1 further comprising the step of:
using a weighted method to change the constraints of the plurality of constraint nodes.

6. The frequency band assignment method of claim 1, wherein the plurality of base stations are operated in a multicast mode.

7. The frequency band assignment method of claim 1, wherein the wireless communication system is a wireless local area network (WLAN).

8. A frequency band assignment device for a wireless communication system, the frequency band assignment device executing the said method of claim 1, to perform frequency assignment for the wireless communication system.
